(19) United States
(12) Patent Application Publication
(10) Pub. No.: US 2018/0224230 A1
(43) Pub. Date: Aug. 9, 2018

(54) GUN VIDEO CAMERA SYSTEM

(71) Applicant: Check 6 Tactical & Training, LLC, Franklinton, NC (US)

(72) Inventors: Jason W. Myers, Franklinton, NC (US); Robert M. Christensen, Stuart, FL (US)

(73) Assignee: Check 6 Tactical & Training, LLC, Franklinton, NC (US)

(21) Appl. No.: 15/425,309

(22) Filed: Feb. 6, 2017

(51) Int. Cl. F41A 17/06; F41G 11/00; F41A 19/11; F41C 33/02; H04N 5/225; H04N 5/77

(52) U.S. Cl. CPC F41A 17/06; F41G 11/003; F41A 19/11; H04N 5/77; F41C 33/0254; F41A 17/063; H04N 5/2252; F41C 33/029

(57) ABSTRACT

The invention is a tamper resistant camera positioned on a gun, for example, mounted on the Weaver/Picatinny rail.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a camera system for use on a gun. In particular, it relates to a tamper resistant video camera system designed to be mounted on a gun such as a hand gun.

### Description of Related Art

The use of a gun in law enforcement is essentially universal to assist an officer in their duties as well as protect the officer from potential injury or death. The presence of a gun means from time to time the gun will be utilized with a suspect and that interaction can result in the suspect's injury or death. It has become increasingly of concern by the public that the use of a gun in such situations are not in keeping with the proper rights and safety of suspects and increased scrutiny of such situations has increasingly occurred. The use of body cams in some instances has attempted to provide evidence of such interactions but the need to constantly record has left issues such as battery operation length of an all-day video and the problem that a body cam is only as good as where the officer's body is pointed and that's not always where a gun is pointed. In addition, watch groups feel that some unscrupulous officers are tampering with the video footage as well as camera and accordingly such video evidence is suspect, and in some cases non-existent.

The thought that a video camera could be attached to a gun means that the camera records what the gun sees regardless of what happens to the officer. Such cameras attached to a gun have been around since at least 1936 but the current camera configurations have serious problems in addressing the fundamental situation. If just a camera is mounted on the gun, nothing prevents tampering of the camera. The video can be easily erased. The camera might have an on/off switch but that can be forgotten about or turned off inappropriately. The camera needs to point where the gun points but in the heat of interacting with a suspect, the camera can get misaligned even with something as simple as drawing the gun from its holster.

### BRIEF SUMMARY OF THE INVENTION

The present invention relates to use of a Hall effect sensor in the camera on a gun which is magnetically triggered on removal of the gun from the holster wherein the camera has constraints on either side of the camera to prevent movement of the camera. In some embodiments, it is designed such that the officer cannot tamper with the camera.

Accordingly, in one embodiment, there is a use of a video camera system for use on a tactical gun having a full trigger guard and stored in a tactical holster wherein the gun is designed for use in tactical situations, the camera system comprising:
a) a video camera;
b) a mounting device which removably attaches the video camera to the tactical gun;
c) a mechanism for automatically turning the camera on in record mode and start recording a video when the gun is removed from the holster and turning the camera and recording off when the gun is replaced in the holster;
d) a battery to power the camera;
e) a memory device for recording video; and
f) wherein the camera is contained in tamper resistant case which is designed to be braced against the sides of the full trigger guard and mounted on the gun using the mounting bracket.

### BRIEF DESCRIPTION OF THE DRAWINGS

FIG. 1 is a side perspective of the invention.

FIG. 2 is a perspective view of the invention.

FIG. 3 is a different perspective view of the camera system.

FIG. 4 is a side view of the system with the gun on a holster.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term “comprising” could be separated into one or more claims using “consisting” or “consisting of” claim language and is so intended.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “video camera system” refers to a digital video camera designed for attachment to a tactical gun used by an officer having a Weaver/Picatinny rail below the barrel on the tactical gun. The camera system is designed to make it difficult for the officer to tamper with the starting and stopping of the video as well as the recording process itself. This is done in order to protect the integrity of any evidence being collected by the camera and prevent a deluding officer from turning the camera off when their gun is in use. The video camera will have a battery to power the device and in some embodiments, can have a charging port and a video download port. In some embodiments, such ports are designed to not be accessible by the officer and require detectable entry methods such as seal breaking specialized tools and the like so such activities are difficult for the officer to perform and thus done back at the station or headquarters after an event where the gun is utilized. In one embodiment, the camera includes audio recording.

As used herein the term “tactical gun or gun” refers to a gun used preemptively, defensively or operationally in a tactical situation, state, or setting, and the like, where benefit can be attained by recording the activity from the gun frontal view. Most all guns can be converted and/or applied as a tactical gun.

As used herein the term “full trigger guard” refers to a protective guard that surrounds the trigger as shown in the Figures. Such trigger guards are standard and well known within the trade.

As used herein the term “tactical holster” refers to a holster that is designed to receive a tactical gun particularly ones, in one embodiment, that are designed to have a flashlight mounted on the Weaver/Picatinny rail since the camera of the present invention is designed of roughly similar dimensions to be able to fit into such tactical holsters. In one embodiment, it is any device that holds the gun.

As used herein the term “tactical situations” refers to a situation where an officer draws his tactical gun from its holster in a situation where the gun might be utilized.

As used herein the term “video camera” refers to a digital camera having a lens design to record to a memory device while the gun is in use or activated.

As used herein the term “tamper resistant case” refers to a case for enclosing the camera, memory device and optional microcontroller constructed in such a way that entry is difficult without leaving traces of such entry such as seals, break off screws and the like. In one embodiment, it is sufficiently difficult to open the case to access the memory or camera and the officer cannot do so in the field and must return to headquarters or the like for any service or downloading of the information contained therein.

As used herein the term “mounting bracket” refers to a mounting bracket positioned on the top of the tamper resistant case designed for removably attaching the camera system to the Weaver/Picatinny rail of the gun. In one embodiment, or other embodiments, it can employ any attachment method including clamping, screwing and the like for attachment to long or short barreled firearms.

As used herein the term “mechanism for automatically turning the camera on” refers to a device in the system such that the camera is turned on when the gun is removed from the holster and turns off when the gun is returned to the holster. The device can be any mechanical or electronic means such as infrared, wireless, mechanical switch or the like. In one embodiment, the device is a Hall effect sensor positioning the camera with a magnet positioned in the holster such that removing the gun causes the magnet to pass the Hall effect sensor which turns it on and the reverse when the gun is placed back in the holster. Since the camera is positioned in front of the trigger guard positioning the magnet or other device in the appropriate area of the holster, it is within the skill in the art in view of the disclosure herein.

As used herein the term “battery” refers to a DC source to power the camera's memory device for recording any microcontroller or other device detection associated with the camera system, like a Wi-Fi or Bluetooth communications module, for sending the recording to a location different from the location of the gun.

As used herein the term “memory device” refers to a recordable memory and a recording device to take the image/video from the camera and record it on a recordable medium like a non-volatile memory card (e.g., multimedia cards, secure digital cards, data storage cards, etc.) or the like.

As used herein the term “braced against the sides of the full trigger guard” refers to the housing of the system being dovetail positioned with constraints at the rear of the case which are positioned on either side of the trigger guard as shown in the Figures. By positioning the constraints on either side of the trigger guard, the casing cannot be moved from vertical orientation when struck since otherwise the attachment to the rail might not be sufficient to cause problems with both steadiness and camera movement relative to the gun barrel. This represents a huge improvement in attachment of a camera in terms of stability and safeguard.

As used herein the term “Hall effect sensor” refers to a transducer that varies its output voltage in response to a magnetic field. Hail effect sensor is used for proximity switching of the camera on and off when a magnet is placed in the holster at the appropriate position. In one embodiment, the system records the gauss strength of the magnet utilized so that one can tell if the magnet in the holster was utilized to turn on or off the camera or some other magnet of different gauss strength. Other sensors (e.g., reed switch and similar) can be used as well to activate the camera upon removal from the holster or the like.

As used herein the term “microcontroller” refers to a computer present in a single integrated circuit which is dedicated to perform limited task and application. For example, coordinating the recording, fault protection, coordinating the Hall effect sensor, coordinating sending the video over Wi-Fi or Bluetooth and the like as needed. The microcontroller functionality can also be embedded within the camera recording device.

As used herein the term “sent wirelessly” refers to having a wireless transmitter in the camera system which can take the video from the camera in the housing and send it to a third location for processing. For example, the system could automatically open an incident report file and place the video taken by the camera in that file thus automatically creating the file necessary for reporting a particular incident by the officer having the gun drawn from the holster.

Optional attachments include a light, or light guide, a power output and the like powered by the camera power source. Lights can be LED, night vision or the like.

In one embodiment, the system is connected to the firing of the gun such that the gun cannot be fired unless the camera is operating. This would require the officer to keep the camera charged and preventing the system not working by just not charging the battery.

### DRAWINGS

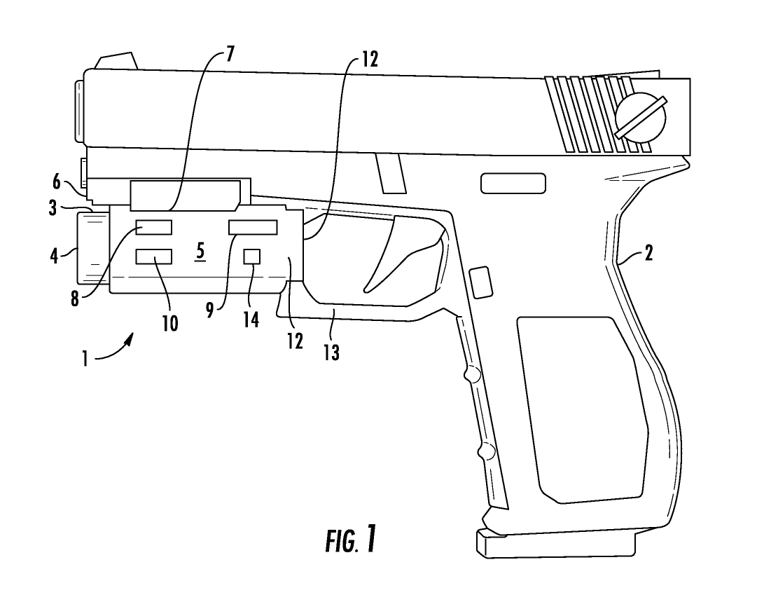

Now referring to the drawings, FIG. 1 is a side view of the camera system 1 mounted on a handgun 2. While one gun type is drawn, others could be substituted. In this view, video camera 3 having lens 4 protruding from case 5 is shown. The case 5 is mounted to the Weaver/Picatinny rail 6 of handgun 2 by mounting bracket 7 which is set-screwed in place on the rail and permanently affixed to the case. Inside the case, shown for clarity, is Hall effect sensor 8 for turning the camera on and off, battery 9, and memory device 10 which include a memory card and a recording device as described above. The case 5 has a constraint 12 on either side of the trigger guard 13 to stabilize and brace the camera against misalignment and other issues. Other devices 14 include Wi-Fi/Bluetooth for sending video to a different location such as an incident case file, a device for measuring and recording gauss strength of the magnet used to turn the device on or off, a device for preventing the handgun from firing unless the camera is operating, microcontroller and the like.

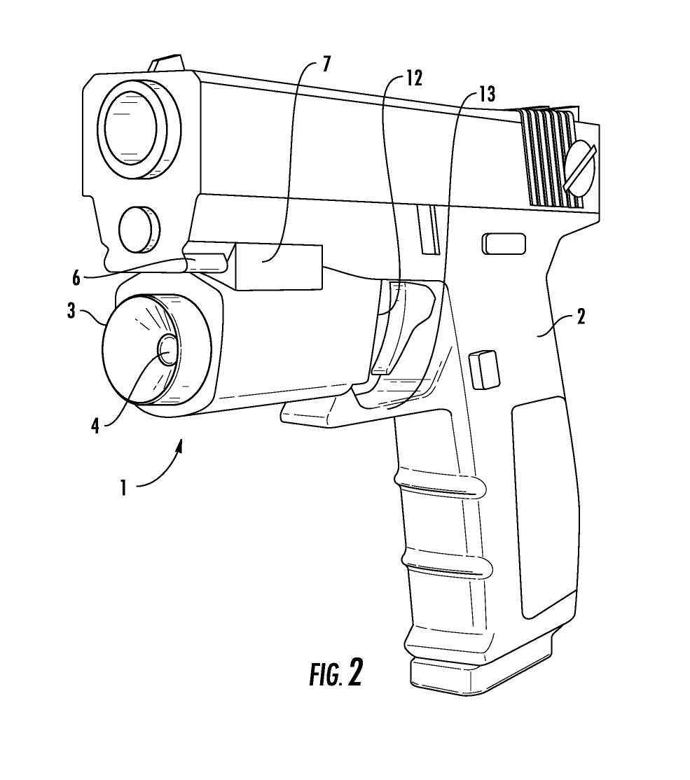

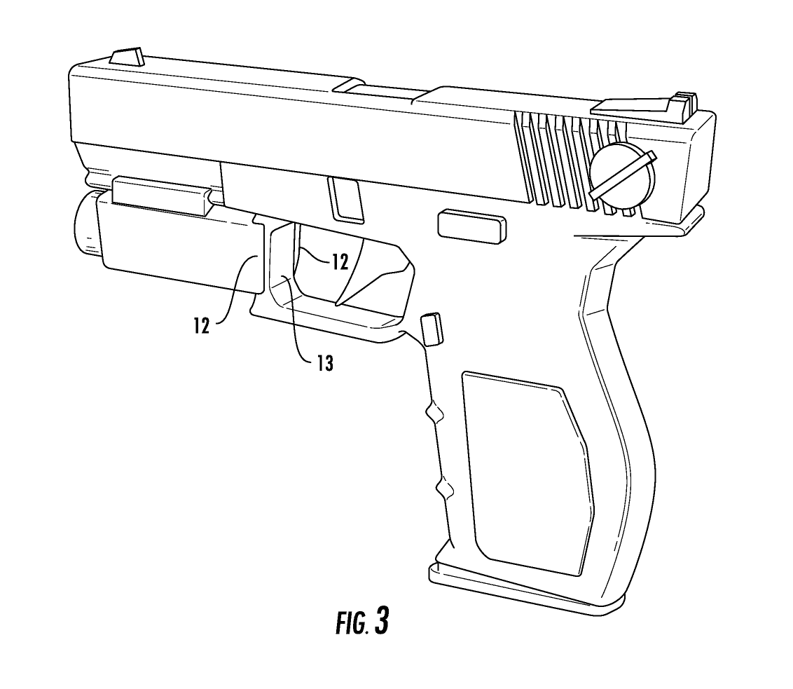

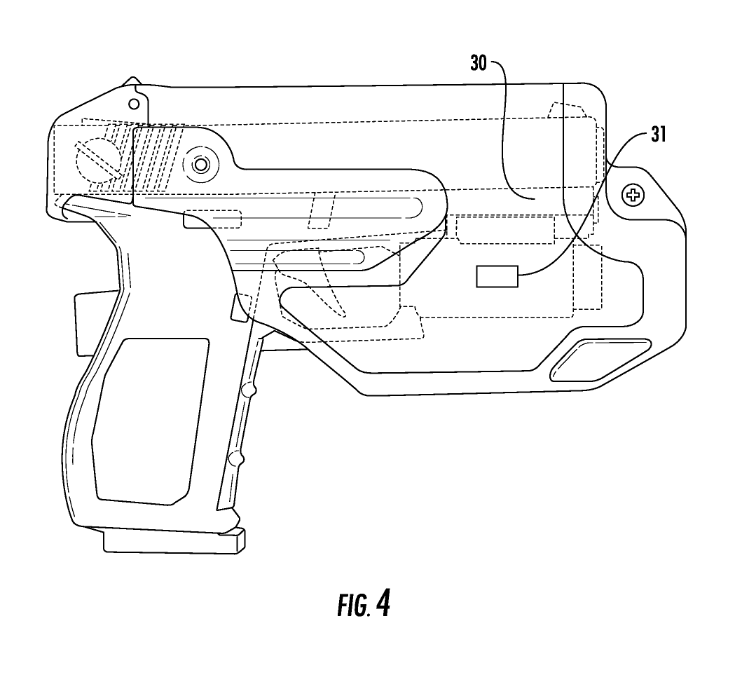

FIG. 2 is a perspective view of the camera system 1. This shows the same features but some are clearer in this view than in a side view. FIG. 3 is a different perspective view of the camera system. FIG. 4 is a side view of the camera system and handgun positioned in a tactical holster 30. In this view, camera in system 1 hidden from view is nestled next to magnet 31 of a selected gauss strength mounted in holster to trigger a Hall effect sensor when the handgun is removed.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A self-contained video camera system for use on a tactical gun having a full trigger guard and stored in a tactical holster wherein the gun is designed for use in tactical situations, the self-contained video camera system consisting essentially of:
a) a video camera;
b) a mounting bracket which removably attaches the video camera to the tactical gun;
c) a mechanical or electronic device consisting of a device that can automatically turn the video camera on in record mode and start recording a video when the tactical gun is removed from the holster and turning the video camera and recording off when the tactical gun is replaced in the holster wherein the camera can only be turned on or off by removal or placement of the gun in the holster;
d) a battery to power the video camera;
e) a recordable medium in the self-contained video camera system for recording video wherein a recorded video on the recordable medium can be accessed by at least one of the group consisting of a video download port and a wireless transmitter;
f) wherein the video camera, the mechanical or electronic device, the battery and the recordable medium are contained in a tamper resistant case, the tamper resistant case which is constructed to be positioned with constraints at the rear of the case which are positioned on either side of the trigger guard; and
g) wherein the video camera system has at least one feature selected from the group consisting of a microcontroller, a light guide, a light, a power output, a charging port, a system that prevents firing of the gun unless the camera is operating and night vision for the camera.

2. (canceled)

3. The self-contained video camera system according to claim 1 wherein the electronic device for automatically turning the video camera on in record mode and start recording a video is turned on using a Hall effect sensor in the camera and a magnet on the holster.

4. The self-contained video camera system according to claim 3 wherein the electronic device records a gauss strength of the magnet used to turn on the video camera recording.

5. (canceled)

6. (canceled)

7. The self-contained video camera system according to claim 1 wherein the tamper resistant case is sized such that when the video camera is mounted on a handgun, the handgun fits in a tactical holster designed for a handgun flashlight attached to a Weaver/Picatinny rail.

8. The self-contained video camera system according to claim 1 which comprises a microcontroller in the tamper resistant case.

9. (canceled)

10. (canceled)

11. (canceled)

12. The self-contained video camera system according to claim 1 wherein the mounting bracket is permanently affixed to the case.

13. The self-contained video camera system according to claim 1 wherein the tamper resistant case is mounted to the tactical gun via a mounting bracket where it attaches to a Weaver/Picatinny rail on the tactical gun.
